(19) United States
(12) Patent Application Publication
(10) Pub. No.: US 2024/0311926 A1
(43) Pub. Date: Sep. 19, 2024

(54) AUTOMATED CLAIM PROCESSING WITH ENDNOTE HIERARCHY

(71) Applicant: Mitchell International, Inc., San Diego, CA (US)

(72) Inventors: SUSAN ENGLEHART, San Diego, CA (US); MICHELE HIBBERT, San Diego, CA (US); MIRIAM ENCARNACION, San Diego, CA (US); VICKI DUNBAR, San Diego, CA (US); WOON KIM, San Diego, CA (US); VALERIE LINDGREN, San Diego, CA (US)

(73) Assignee: Mitchell International, Inc., San Diego, CA (US)

(21) Appl. No.: 18/671,270

(22) Filed: May 22, 2024

Related U.S. Application Data
(63) Continuation-in-part of application No. 17/010,712, filed on Sep. 2, 2020, now abandoned.

(51) Int. Cl. G06Q 40/08

(52) U.S. Cl. CPC G06Q 40/08

(57) ABSTRACT

In some embodiments, a computer-implemented method comprises: storing associations between explanation codes and hierarchical ranks in a database; receiving a first electronic document representing an insurance claim comprising a line comprising a procedure code and at least two explanation codes; determining hierarchical ranks for the explanation codes by at least one of: applying the explanation codes to the database, and executing rules selected according to the explanation codes; determining, according to the determined hierarchical ranks, whether the line should be modified; modifying the line; ordering the explanation codes according to the hierarchical ranks; providing a user interface displaying the modified line with the ordered explanation codes and user-operable controls; adjusting the line responsive to user operation of the user-operable controls; and outputting a second electronic document representing the insurance claim after adjusting the line.

### CROSS REFERENCE TO RELATED APPLICATIONS

The present application is a continuation-in-part of U.S. patent application Ser. No. 17/010,712, filed Sep. 2, 2020, entitled “AUTOMATED CLAIM PROCESSING WITH ENDNOTE HIERARCHY,” the disclosure thereof incorporated by reference herein in its entirety.

### DESCRIPTION OF RELATED ART

The disclosed technology relates generally to systems for insurance claim workflows, and more particularly, some embodiments relate to automation of those workflows.

### SUMMARY

A claimed solution rooted in computer technology overcomes problems specifically arising in the realm of computer technology.

In general, one aspect disclosed features a system, comprising: one or more hardware processors; and one or more non-transitory machine-readable storage media encoded with instructions executable by the one or more hardware processors to perform operations comprising: storing, in a database of explanation code ranks, associations between a plurality of explanation codes and a plurality of hierarchical ranks; receiving, from a claims generator, a first electronic document representing an insurance claim, wherein the electronic document representing the insurance claim comprises at least one line, and wherein at least one line comprises at least one procedure code and at least two explanation codes; determining hierarchical ranks from a plurality of the hierarchical ranks for the at least two explanation codes in the at least one line by at least one of: applying the at least two explanation codes to the database of explanation code ranks, and executing one or more logic rules selected according to the at least two explanation codes; determining, according to the determined hierarchical ranks of the at least two explanation codes, whether the at least one line should be modified; modifying the at least one line when it is determined that the at least one line should be modified; ordering the explanation codes in the modified at least one line according to the hierarchical ranks; providing a user interface comprising (i) display elements representing the modified at least one line with the ordered explanation codes and (ii) one or more user-operable controls operable by a user to adjust the at least one line; adjusting the at least one line responsive to user operation of the one or more user-operable controls; and outputting a second electronic document representing the insurance claim after adjusting the at least one line.

Embodiments of the system may include one or more of the following features. In some embodiments, the operations further comprise: transmitting the second electronic document to a claims management system for review by an analyst. In some embodiments, the operations further comprise: determining, according to a modifier in the at least one line, whether the at least one line should be modified. In some embodiments, modifying the at least one line comprises: selecting one of the procedure codes from the at least one line of the electronic document representing the insurance claim; and modifying the at least one line according to the selected procedure code. In some embodiments, modifying the at least one line comprises: modifying at least one of the explanation codes in the at least one line. In some embodiments, modifying the at least one line comprises: deleting at least one of the explanation codes in the at least one line. In some embodiments, the operations further comprise: determining, according to the at least one procedure code in the at least one line, whether the at least one line should be modified.

In general, one aspect disclosed features one or more non-transitory machine-readable storage media encoded with instructions that, when executed by one or more hardware processors of a computing system, cause the computing system to perform operations comprising: storing, in a database of explanation code ranks, associations between a plurality of explanation codes and a plurality of hierarchical ranks; receiving, from a claims generator, a first electronic document representing an insurance claim, wherein the electronic document representing the insurance claim comprises at least one line, and wherein at least one line comprises at least one procedure code and at least two explanation codes; determining hierarchical ranks from a plurality of the hierarchical ranks for the at least two explanation codes in the at least one line by at least one of: applying the at least two explanation codes to the database of explanation code ranks, and executing one or more logic rules selected according to the at least two explanation codes; determining, according to the determined hierarchical ranks of the at least two explanation codes, whether the at least one line should be modified; modifying the at least one line when it is determined that the at least one line should be modified; ordering the explanation codes in the modified at least one line according to the hierarchical ranks; providing a user interface comprising (i) display elements representing the modified at least one line with the ordered explanation codes and (ii) one or more user-operable controls operable by a user to adjust the at least one line; adjusting the at least one line responsive to user operation of the one or more user-operable controls; and outputting a second electronic document representing the insurance claim after adjusting the at least one line.

Embodiments of the media may include one or more of the following features. In some embodiments, the operations further comprise: transmitting the second electronic document to a claims management system for review by an analyst. In some embodiments, the operations further comprise: determining, according to a modifier in the at least one line, whether the at least one line should be modified. In some embodiments, modifying the at least one line comprises: selecting one of the procedure codes from the at least one line of the electronic document representing the insurance claim; and modifying the at least one line according to the selected procedure code. In some embodiments, modifying the at least one line comprises: modifying at least one of the explanation codes in the at least one line. In some embodiments, modifying the at least one line comprises: deleting at least one of the explanation codes in the at least one line. In some embodiments, the operations further comprise: determining, according to the at least one procedure code in the at least one line, whether the at least one line should be modified.

In general, one aspect disclosed features a computer-implemented method comprising: storing, in a database of explanation code ranks, associations between a plurality of explanation codes and a plurality of hierarchical ranks; receiving, from a claims generator, a first electronic document representing an insurance claim, wherein the electronic document representing the insurance claim comprises at least one line, and wherein at least one line comprises at least one procedure code and at least two explanation codes; determining hierarchical ranks from a plurality of the hierarchical ranks for the at least two explanation codes in the at least one line by at least one of: applying the at least two explanation codes to the database of explanation code ranks, and executing one or more logic rules selected according to the at least two explanation codes; determining, according to the determined hierarchical ranks of the at least two explanation codes, whether the at least one line should be modified; modifying the at least one line when it is determined that the at least one line should be modified; ordering the explanation codes in the modified at least one line according to the hierarchical ranks; providing a user interface comprising (i) display elements representing the modified at least one line with the ordered explanation codes and (ii) one or more user-operable controls operable by a user to adjust the at least one line; adjusting the at least one line responsive to user operation of the one or more user-operable controls; and outputting a second electronic document representing the insurance claim after adjusting the at least one line.

Embodiments of the system may include one or more of the following features. Some embodiments comprise: transmitting the second electronic document to a claims management system for review by an analyst. Some embodiments comprise: determining, according to a modifier in the at least one line, whether the at least one line should be modified. In some embodiments, modifying the at least one line comprises: selecting one of the procedure codes from the at least one line of the electronic document representing the insurance claim; and modifying the at least one line according to the selected procedure code. In some embodiments, modifying the at least one line comprises: modifying at least one of the explanation codes in the at least one line. In some embodiments, modifying the at least one line comprises: deleting at least one of the explanation codes in the at least one line.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an insurance claims workflow automation system according to some embodiments of the disclosed technology.

FIG. 2 shows a table of types of explanation codes according to some embodiments of the disclosed technology.

FIG. 3 shows a table of hierarchical ranks of explanation codes according to some embodiments of the disclosed technology.

FIG. 4 illustrates a process for insurance claims workflow automation according to some embodiments of the disclosed technology.

FIGS. 5-7 show user interfaces provided by the insurance claims workflow automation system according to some embodiments of the disclosed technology.

FIG. 8 illustrates a process for determining hierarchical ranks of explanation codes according to some embodiments of the disclosed technology.

FIG. 9 shows an example insurance claim.

FIG. 10 shows an example insurance claim.

FIG. 11 is an example computing component that may be used to implement various features of embodiments described in the present disclosure.

The figures are not exhaustive and do not limit the present disclosure to the precise form disclosed.

### DETAILED DESCRIPTION

With the advent of high-power, cost effective computing systems came the increased automation of numerous facets of our contemporary society. In the insurance and other casualty and loss industries, for example, computerized claims estimating, processing, tracking and payment systems have long been in use to streamline processes and to expedite claims handling and closure.

Despite these advances, the insurance claim workflow remains a long and tedious process, requiring input and review from multiple parties involved in the workflow. In some cases this process produces flawed insurance claims, requiring correction by a human analyst. For example, an insurance claim may include a number of lines, each for a particular procedure, and each including one or more explanation codes that map to explanations of why the procedure was allowed, denied, price reduced, and the like. In some cases these explanation codes may be erroneous, and may conflict with other explanation codes. One way to improve the insurance claim workflow is to reduce the number of such conflicts.

In this description, various embodiments are disclosed for medical insurance claim workflow automation. However, embodiments of the disclosed technology apply to other types of workflows as well. For example, embodiments may apply to other types of insurance claims, to similar workflows, and the like. These and other applications will be apparent to one skilled in the relevant art after reading this description. Before describing embodiments of the disclosed technology in detail, it is useful to describe an example environment in which the disclosed technology may be implemented.

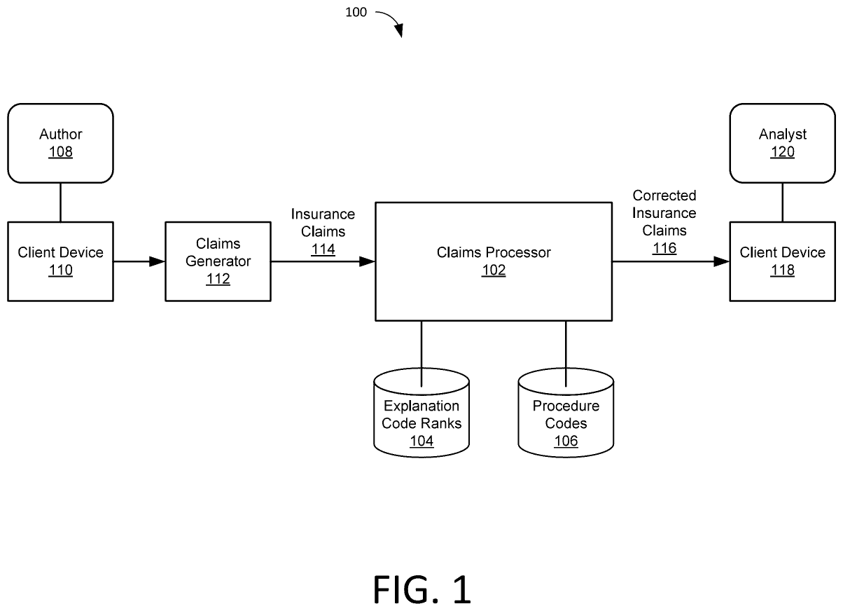

FIG. 1 illustrates an insurance claims workflow automation system 100 according to some embodiments of the disclosed technology. Referring to FIG. 1, the system may include a claims processor 102. In the described embodiments, the claims processor 102 may ingest insurance claim 114, and may process the ingested insurance claim 114 to produce corrected insurance claims 116. The claims processor 102 may be implemented as a server computer.

The insurance claim 114 may be generated by an author 108 employing one or more computing devices. For example, the author 108 may employ a client device 110 to interact with a claims generator 112. In this example, the client device 110 may be implemented as a desktop, laptop, tablet, smartphone, or the like, while the claims generator 112 may be implemented as a server computer. In the example of FIG. 1, any communications between elements may be direct or networked. The claims processor 102 and the claims generator 112 may be implemented together as a single device.

An analyst 120 may access the corrected insurance claim 116 using a client device 118. The client device 118 may be implemented as a desktop, laptop, tablet, smartphone, or the like. The client devices 110 and 118 may be part of one or more claims management systems.

In processing the ingested insurance claim 114, the claims processor 102 may communicate with one or more databases, which may include a database 104 of explanation code ranks and a database 106 of procedure codes. The database 104 of explanation code ranks may contain predetermined associations between explanation codes and a plurality of ranks, which may include display rank IDs and/or hierarchical ranks. For example, each explanation code may be assigned a particular rank in a set of the ranks. In some embodiments, the ranks are assigned to explanation codes according to the types of the explanation codes.

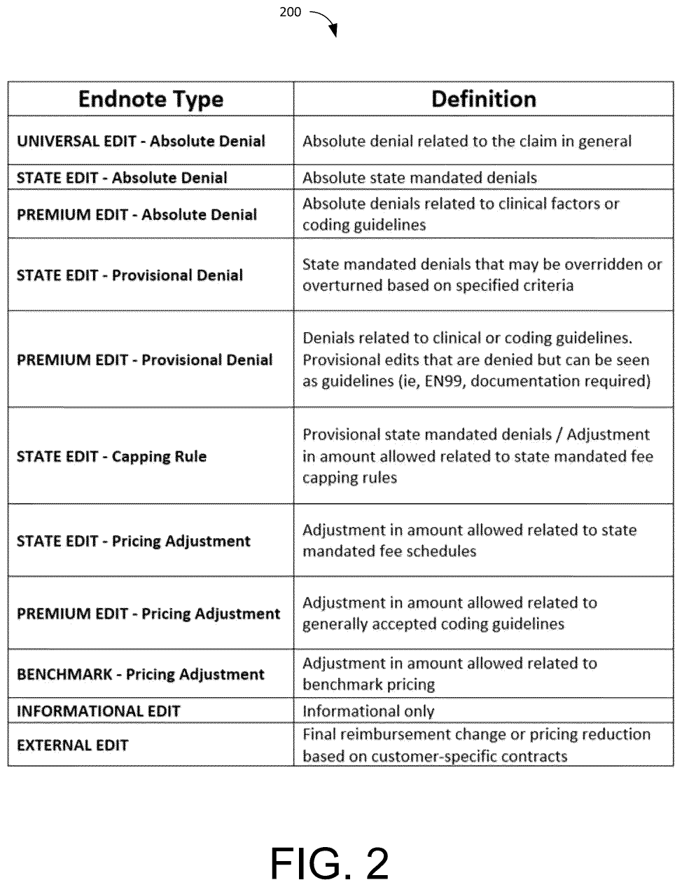

FIG. 2 shows a table 200 of types of explanation codes according to some embodiments of the disclosed technology. In the insurance industry, explanation codes are also referred to as “reason codes”, “endnotes”, and “edits”. In this description, these terms are all used interchangeably. The explanation codes may be used to apply business rules which are based on different medical billing requirements resources including (but not limited to) CPT (Current Procedural Terminology) coding guidelines, state mandated fee schedule guidelines, clinical appropriateness guidelines, and the like. While the example of FIG. 2 defines a particular set of explanation code types, other embodiments may define other sets of explanation code types.

Referring to FIG. 2, the table 200 includes two columns. The left column lists types of endnotes, while the right column lists the definitions of the endnote types. The “UNIVERSAL EDIT-Absolute Denial” endnote type indicates an absolute denial related to the claim in general. Absolute denial means the claim will not be paid under any circumstances. The “STATE EDIT—Absolute Denial” endnote type indicates an absolute denial that is mandated by the rules of a particular state.

The “PREMIUM EDIT-Absolute Denial” indicates an absolute denial that is related to clinical factors or coding guidelines. The “STATE EDIT-Provisional Denial” indicates a provisional denial that is mandated by the rules of a particular state. Provisional denial means that the denial may be overridden or overturned based on specified criteria. The “PREMIUM EDIT—Provisional Denial” indicates a provisional denial related to clinical factors or coding guidelines. For example, an endnote value of EN99 indicates a provisional denial that may be overturned by providing required documentation.

The “STATE EDIT-Capping Rule” indicates a provisional denial or adjustment in amount allowed related to fee capping rules mandated by a particular state. The “STATE EDIT—Pricing Adjustment” indicates an adjustment in amount allowed related to state-mandated fee schedules. The “PREMIUM EDIT-Pricing Adjustment” indicates an adjustment in amount allowed related to generally accepted coding guidelines. The “BENCHMARK-Pricing Adjustment” indicates an adjustment in amount allowed related to benchmark pricing. The “INFORMATIONAL EDIT” is informational only. The “EXTERNAL EDIT” indicates a final reimbursement change or pricing reduction based on customer-specific contracts or medical/service provider contracts.

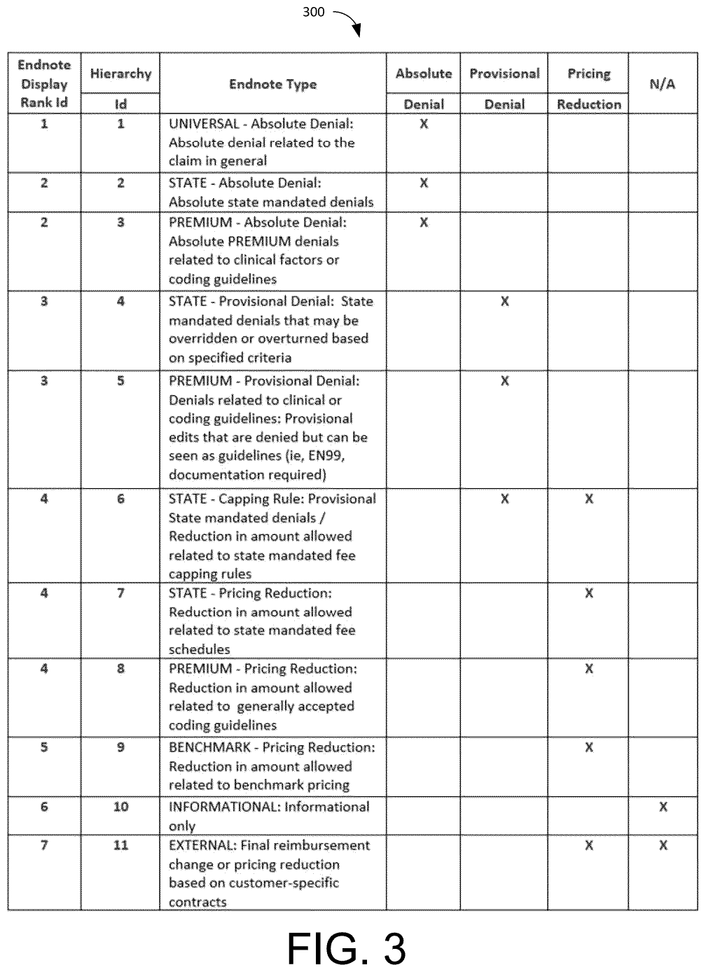

FIG. 3 shows a table 300 of hierarchical ranks of explanation codes according to some embodiments of the disclosed technology. Referring to FIG. 3, table 300 includes seven columns. The third column lists the endnote type. The first column lists the endnote display rank ID, which may be used to determine the order in which the endnotes are displayed in each line of the insurance claim, with the highest-ranked endnote being displayed first.

The second column lists the hierarchical rank (also referred to herein as the “hierarchy ID”) for each endnote type. In the example of FIG. 3, the endnotes are ranked in the same order as listed in table 200 of FIG. 2. In the described embodiments, each endnote type has a different rank. However, in other embodiments, two or more endnote types may have the same rank, and the ranks may differ from those in the example of FIG. 3.

The fourth, fifth, and sixth columns categorize the endnotes in three different categories: absolute denial, provisional denial, and pricing reduction. The seventh column indicates which endnotes have no category (N/A).

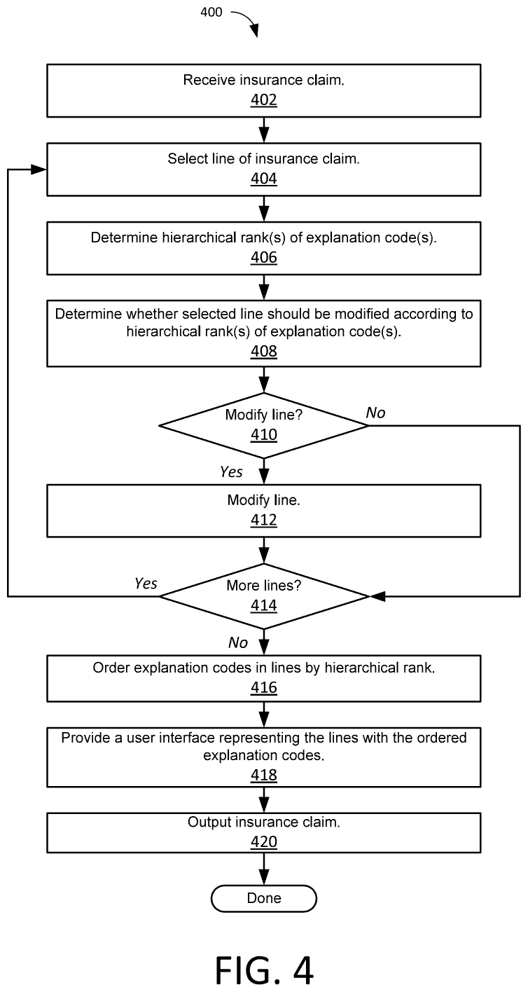

FIG. 4 illustrates a process 400 for insurance claims workflow automation according to some embodiments of the disclosed technology. The process 400 may be performed, for example, by the claims processor 102 of the insurance claims workflow automation system 100 of FIG. 1. The elements of process 400 are presented in a particular order. However, it should be understood that, in various embodiments, one or more elements may be performed in a different order, in parallel, or omitted. Furthermore, the process 400 may include other elements in addition to those presented. For example, the process 400 may include error-handling functions if exceptions occur, and the like.

Referring to FIG. 4, the process 400 may begin with receiving an insurance claim, at 402. In the example of FIG. 1, the claims processor 102 may receive the insurance claim 114 from the claims generator 112. The insurance claim 114 may be received as an electronic document, or the like.

Referring again to FIG. 4, the process 400 may include selecting a line of the insurance claim, at 404. Each line of insurance claim includes a plurality of fields, for example as discussed in detail below. For example, the fields may include the date of service, the procedure code or drug code, the amount charged, the amount allowed, and one or more endnotes. The lines are numbered consecutively, and are generally processed in that order, although this is not required.

The process 400 may include determining the hierarchical rank of each explanation code in the selected line of the insurance claim, at 406. In the example of FIG. 1, the claims processor 102 may determine the hierarchical rank of each explanation code with reference to the database 104 of explanation code ranks. The hierarchical ranks of the explanation codes may be as shown in the example of FIG. 3.

Referring again to FIG. 4, the process 400 may include determining whether the selected line should be modified according to the hierarchical ranks of the explanation codes in the selected line, at 408. For example, when two explanation codes in a line conflict with each other, the explanation code with a higher hierarchical rank may be retained in the line, while the explanation code with the lower hierarchical rank may be deleted from the line.

In some embodiments, the determination of whether the selected line should be modified may include consideration of one or more other lines in the estimate. For example, the selected line may be considered an “add-on” line that depends on another “base” or “primary” line. In this example, the selected line may be modified to add, modify, or remove one or more explanation codes to account for this dependency.

In some embodiments, the determination of whether the selected line should be modified may include consideration of a modifier code in the line. For example, within the medical billing industry modifier codes refer to two-character codes that provide a means for reporting or indicating that a service or procedure that has been performed has been altered by some specific circumstance, but the definition of the original procedure or service has not changed. Modifiers also enable health care professionals to effectively respond to payment policy requirements established by other entities, including payers.

In some embodiments, the determination of whether the selected line should be modified may include consideration of the procedure code for the selected line and/or another line of the insurance claim. This may be the case, for example, when the selected line is an “add-on” line or “primary” line. In the example of FIG. 1, the claims processor 102 may access the database 106 of procedure codes.

Referring again to FIG. 4, when it is determined that the selected line should be modified, at 410, the process 400 may include modifying the selected line, at 412. The selected line may be modified as described in the examples above, and in the examples that follow.

When the insurance claim includes more lines to be processed, at 414, part of the process 400 may repeat, resuming at 404. When all of the lines of the insurance claim have been processed, at 414, the process 400 may include ordering the explanation codes in each line according to their hierarchical ranks, at 416. For example, in each line the explanation code having the highest rank may be listed first. This arrangement enables a user to review the explanation codes in order of importance. For example, referring again to table 300 of FIG. 3, when a line includes an explanation code having the highest hierarchical rank of 1, corresponding to universal absolute denial, one or more other explanation codes of lesser hierarchical rank may be ignored and/or removed from the line. Therefore it is helpful that the system lists the explanation code with the highest hierarchical rank first.

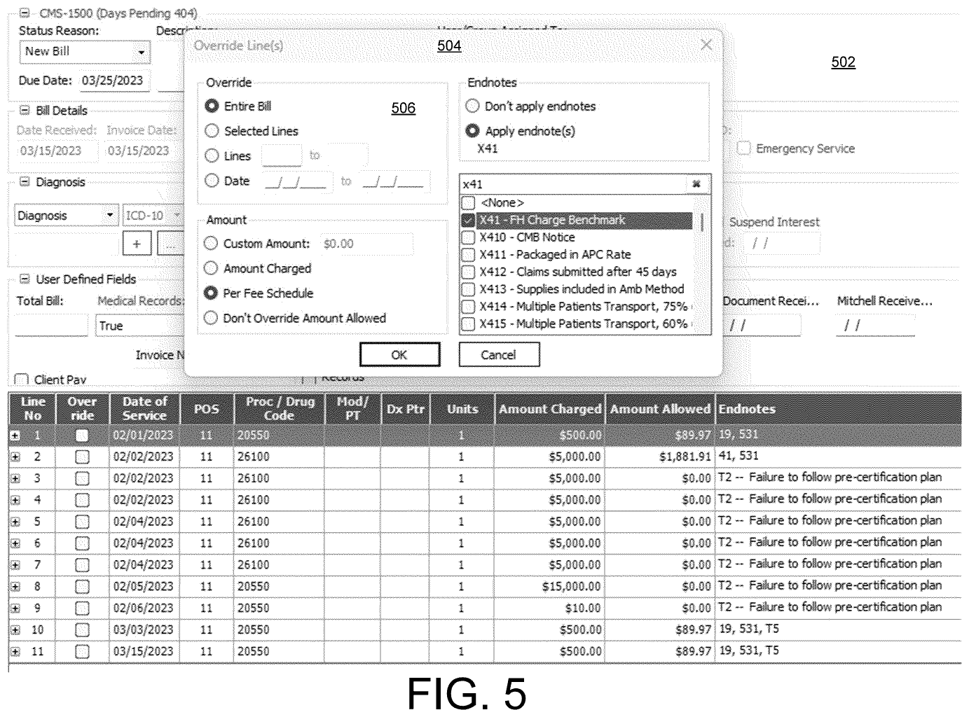

Referring again to FIG. 4, the process 400 may include providing a user interface representing the lines with the ordered explanation codes, at 418. The user interface may include (i) display elements representing at least one line with the ordered explanation codes and (ii) one or more user-operable controls operable by a user to adjust the one or more lines. At this point the user may accept or adjust lines of the insurance claim. Adjusting the lines may include changing values in the lines, adding new lines, and/or deleting lines. For example, the insurance claims workflow automation system provides an override feature that allows the user to replace certain data with other data, as described below with reference to FIGS. 5-7.

Referring again to FIG. 4, after the user has accepted the insurance claim, the process 400 may include outputting the insurance claim, at 420, for example as an electronic document. In the example of FIG. 1, the claims processor 102 may output the corrected insurance claim 116, and may provide the corrected insurance claim 116 to the client device 118 for review by an analyst 120.

FIGS. 5-7 show user interfaces provided by the insurance claims workflow automation system according to some embodiments of the disclosed technology. The user interfaces include display elements representing claim lines and user-operable controls operable by a user to adjust the lines. Referring to FIG. 5, the user has invoked the override feature for an insurance claim 502, and in response the system has provided an override control panel 504. The override control panel 504 enables the user to override the entire bill, selected lines, a range of lines, and lines within a date range, at 506.

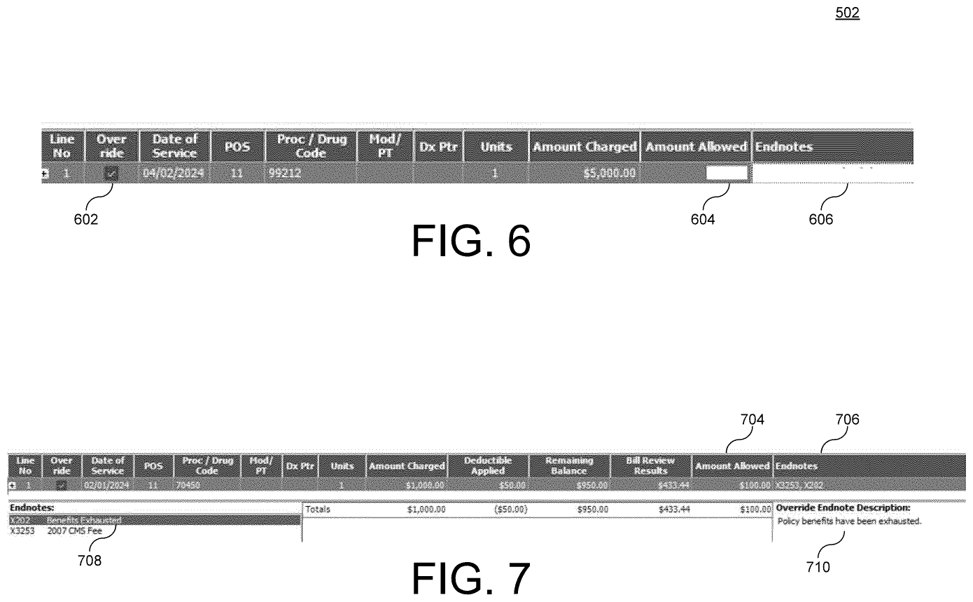

Referring to FIG. 6, the user has elected to override line 1 by checking Override box 602 in line 1. Responsive to this election, the system has modified the display of the line to allow data entry in the Amount Allowed field 604 and the Endnotes field 606.

Referring to FIG. 7, the user has entered an Amount Allowed of $100 at 704 and an Endnote code of X202 at 706. Endnote code X202 indicates the policy benefits have been exhausted, as noted at 708 and 710.

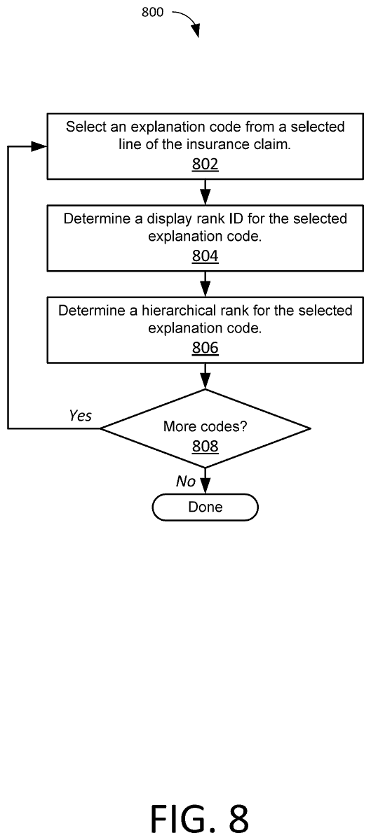

FIG. 8 illustrates a process 800 for determining hierarchical ranks of explanation codes according to some embodiments of the disclosed technology. The process 800 may be performed, for example, by the claims processor 102 of the insurance claims workflow automation system 100 of FIG. 1. The process 800 may correspond to process 406 of FIG. 4. The elements of process 800 are presented in a particular order. However, it should be understood that, in various embodiments, one or more elements may be performed in a different order, in parallel, or omitted. Furthermore, the process 800 may include other elements in addition to those presented. For example, the process 800 may include error-handling functions if exceptions occur, and the like.

Referring to FIG. 8, the process 800 may begin with selecting an explanation code from a selected line of the insurance claim, at 802. The process may continue with determining a display rank ID for the selected explanation code, at 804. In some embodiments, the display rank ID may be provided as part of the insurance claim. In other embodiments, the display rank ID may be generated by the insurance claims workflow automation system. For example, referring to FIG. 1, the display rank ID may be generated by the claims processor 102. The claims processor 102 may generate the display rank ID by applying the selected explanation code as a key in a lookup of the database of explanation code ranks 104. The claims processor 102 may generate the display rank ID by application of one or more predetermined logic rules. The claims processor 102 may generate the display rank ID using one or more logic rules and one or more database lookups.

Referring again to FIG. 8, the process 800 may include determining a hierarchical rank for the selected explanation code, at 806. For example, referring again to FIG. 1, the hierarchical rank may be generated by the claims processor 102. The claims processor 102 may generate the hierarchical rank by applying the display rank ID of the selected explanation code as a key in a lookup of the database of explanation code ranks 104. For example, the claims processor 102 may apply the display rank ID to table 300 of FIG. 3 to determine the corresponding hierarchical rank. The claims processor 102 may generate the hierarchical rank by the application of one or more predetermined logic rules. The claims processor 102 may generate the hierarchical rank using one or more logic rules and one or more database lookups.

When the selected line of the insurance claim includes more explanation codes to be processed, at 808, part of the process 800 may repeat, resuming at 802. When all of the explanation codes of the selected line of the insurance claim have been processed, at 808, the process 800 ends.

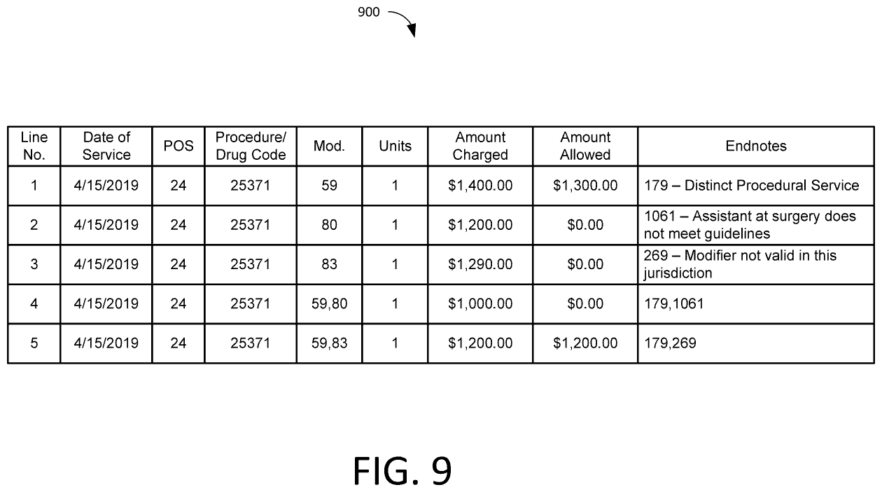

FIG. 9 shows an example insurance claim 900. The example insurance claim 900 includes 5 lines, labeled 1-5. All of the lines have the same procedure code, 25371. In line 1, the modifier code 59 indicates the procedure code applies to all of the states, and the endnote 179 indicates that the bill line is allowed.

In line 2, the modifier 80 indicates the procedure code applies to all states, but the endnote 1061 indicates that the bill line is denied according to “Assistant at Surgery” rules.

In line 3, the modifier 83 indicates the procedure code applies only in New York state, and the endnote 269 indicates that the bill line is denied as not valid for that state.

In line 4, the combination of modifiers 59 and 80 indicate that the procedure code applies to all of the states, but the endnotes conflict. In particular, the endnote 179 indicates that the bill line is allowed, while the endnote 1061 indicates that the bill line is denied according to “Assistant at Surgery” rules. In this case, endnote 1061 is the higher priority edit. The system appropriately accepts the higher priority edit and the result is an appropriate denial of payment (Amount Allowed=$0.00). Therefore, the system retains the endnote 1061 in the bill line.

In line 5, the combination of modifiers 59 and 83 indicate that the procedure code applies to all of the states, but the endnotes conflict. In particular, the endnote 179 indicates that the bill line is allowed, while the endnote 269 indicates that the bill line is denied. The endnote 269 has a higher hierarchical rank than the endnote 179. Therefore, the system retains the endnote 269 in the bill line, while deleting the endnote 179, and the result is an appropriate denial of payment (Amount Allowed=$0.00).

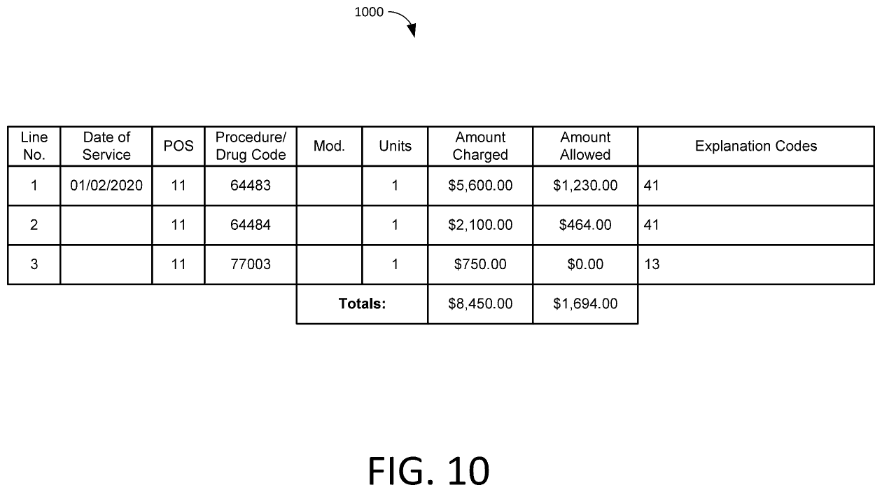

FIG. 10 shows an example insurance claim 1000. The example insurance claim 1000 includes 3 lines, labeled 1-3, which have procedure codes 64483, 64484, and 77003, respectively. The procedure code 77003 is for “Fluoroscopic guidance and localization of needle or catheter tip for spine or paraspinous diagnostic or therapeutic injection procedures (epidural or subarachnoid) (List separately in addition to code for primary procedure)” changed from a “Primary” (Base) code to a designated “Add-on” code as denoted by the “+” symbol and the “(List separately in addition to code for primary procedure)” within the code descriptor in CPT. Additionally, the services described for procedure code 64483 “Injection(s), anesthetic agent and/or steroid, transforaminal epidural, with imaging guidance (fluoroscopy or CT); lumbar or sacral, single level” include imaging guidance (fluoroscopy or CT) as stated within the code descriptor. The correct explanation code should be 11 for line No. 1, which indicates the inclusive relationship between the two procedure codes, namely that procedure code 77003 is considered a component service within procedure code 64483. But the explanation code produced by the claims generator is 13, which indicates that the line will be denied because the procedure code 77003 is an “add-on” code without a “primary” or “base” code. In this case, endnote 11 is the higher priority edit, and therefore endnote 13 should not generate.

Embodiments of the disclosed technology may provide several advantages compared with previous solutions. The disclosed technology may allow users to adjudicate medical bills using data to more effectively make informed and consistent claim payment decisions. The disclosed technology may reduce conflicts in the endnotes of insurance claims, resulting in fewer processing iterations, and less manual review and adjustment.

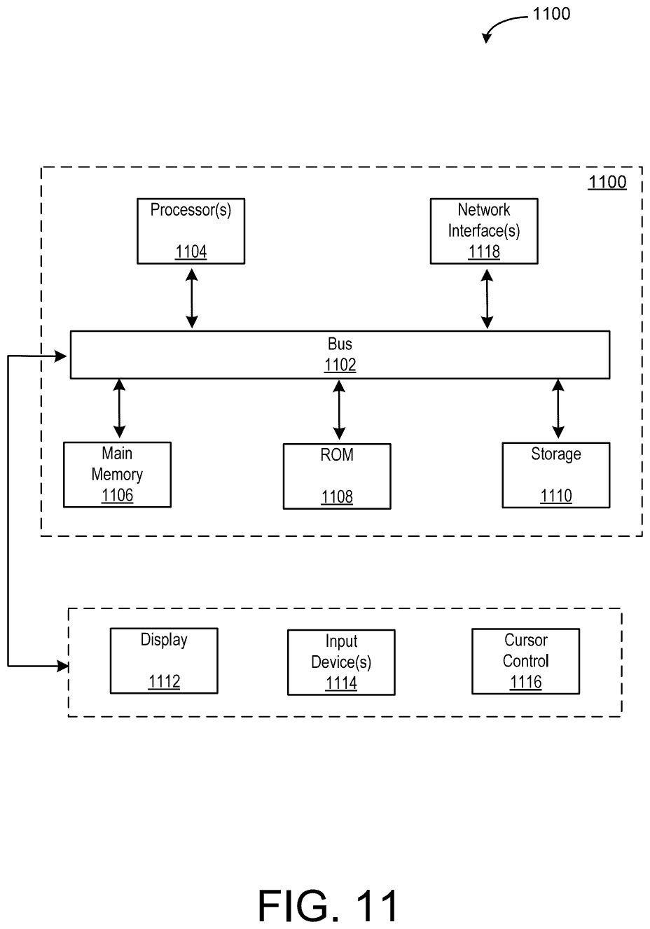

FIG. 11 depicts a block diagram of an example computer system 1100 in which embodiments described herein may be implemented. The computer system 1100 includes a bus 1102 or other communication mechanism for communicating information, one or more hardware processors 1104 coupled with bus 1102 for processing information. Hardware processor(s) 1104 may be, for example, one or more general purpose microprocessors.

The computer system 1100 also includes a main memory 1106, such as a random access memory (RAM), cache and/or other dynamic storage devices, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions.

The computer system 1100 further includes a read only memory (ROM) 1108 or other static storage device coupled to bus 1102 for storing static information and instructions for processor 1104. A storage device 1110, such as a magnetic disk, optical disk, or USB thumb drive (Flash drive), etc., is provided and coupled to bus 1102 for storing information and instructions.

The computer system 1100 may be coupled via bus 1102 to a display 1112, such as a liquid crystal display (LCD) (or touch screen), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. In some embodiments, the same direction information and command selections as cursor control may be implemented via receiving touches on a touch screen without a cursor.

The computing system 1100 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C, C++, and Python. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor(s) 1104 executing one or more sequences of one or more instructions contained in main memory 1106. Such instructions may be read into main memory 1106 from another storage medium, such as storage device 1110. Execution of the sequences of instructions contained in main memory 1106 causes processor(s) 1104 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1110. Volatile media includes dynamic memory, such as main memory 1106. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1102. Transmission media can also take the form of acoustic or light waves, such as those generated during radio-wave and infra-red data communications.

The computer system 1100 also includes a communication interface 1118 coupled to bus 1102. Network interface 1118 provides a two-way data communication coupling to one or more network links that are connected to one or more local networks. For example, communication interface 1118 may be an integrated services digital network (ISDN) card, cable modem, satellite modem, or a modem to provide a data communication connection to a corresponding type of telephone line. As another example, network interface 1118 may be a local area network (LAN) card to provide a data communication connection to a compatible LAN (or a WAN component to communicate with a WAN). Wireless links may also be implemented. In any such implementation, network interface 1118 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 1118, which carry the digital data to and from computer system 1100, are example forms of transmission media.

The computer system 1100 can send messages and receive data, including program code, through the network(s), network link and communication interface 1118. In the Internet example, a server might transmit a requested code for an application program through the Internet, the ISP, the local network and the communication interface 1118.

The received code may be executed by processor 1104 as it is received, and/or stored in storage device 1110, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (Saas). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICS, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1100.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system, comprising:
one or more hardware processors; and
one or more non-transitory machine-readable storage media encoded with instructions executable by the one or more hardware processors to perform operations comprising:
storing, in a database of explanation code ranks, associations between a plurality of explanation codes and a plurality of hierarchical ranks;
receiving, from a claims generator, a first electronic document representing an insurance claim, wherein the electronic document representing the insurance claim comprises at least one line, and wherein at least one line comprises at least one procedure code and at least two explanation codes;
determining hierarchical ranks from a plurality of the hierarchical ranks for the at least two explanation codes in the at least one line by at least one of:
applying the at least two explanation codes to the database of explanation code ranks, and
executing one or more logic rules selected according to the at least two explanation codes;
determining, according to the determined hierarchical ranks of the at least two explanation codes, whether the at least one line should be modified;
modifying the at least one line when it is determined that the at least one line should be modified;
ordering the explanation codes in the modified at least one line according to the hierarchical ranks;
providing a user interface comprising (i) display elements representing the modified at least one line with the ordered explanation codes and (ii) one or more user-operable controls operable by a user to adjust the at least one line;
adjusting the at least one line responsive to user operation of the one or more user-operable controls; and
outputting a second electronic document representing the insurance claim after adjusting the at least one line.

2. The system of claim 1, the operations further comprising:
transmitting the second electronic document to a claims management system for review by an analyst.

3. The system of claim 1, the operations further comprising:
determining, according to a modifier in the at least one line, whether the at least one line should be modified.

4. The system of claim 1, wherein modifying the at least one line comprises:
selecting one of the procedure codes from the at least one line of the electronic document representing the insurance claim; and
modifying the at least one line according to the selected procedure code.

5. The system of claim 1, wherein modifying the at least one line comprises:
modifying at least one of the explanation codes in the at least one line.

6. The system of claim 1, wherein modifying the at least one line comprises:
deleting at least one of the explanation codes in the at least one line.

7. The system of claim 1, the operations further comprising:
determining, according to the at least one procedure code in the at least one line, whether the at least one line should be modified.

8. One or more non-transitory machine-readable storage media encoded with instructions that, when executed by one or more hardware processors of a computing system, cause the computing system to perform operations comprising:
storing, in a database of explanation code ranks, associations between a plurality of explanation codes and a plurality of hierarchical ranks;
receiving, from a claims generator, a first electronic document representing an insurance claim, wherein the electronic document representing the insurance claim comprises at least one line, and wherein at least one line comprises at least one procedure code and at least two explanation codes;
determining hierarchical ranks from a plurality of the hierarchical ranks for the at least two explanation codes in the at least one line by at least one of:
applying the at least two explanation codes to the database of explanation code ranks, and
executing one or more logic rules selected according to the at least two explanation codes;
determining, according to the determined hierarchical ranks of the at least two explanation codes, whether the at least one line should be modified;
modifying the at least one line when it is determined that the at least one line should be modified;
ordering the explanation codes in the modified at least one line according to the hierarchical ranks;
providing a user interface comprising (i) display elements representing the modified at least one line with the ordered explanation codes and (ii) one or more user-operable controls operable by a user to adjust the at least one line;
adjusting the at least one line responsive to user operation of the one or more user-operable controls; and
outputting a second electronic document representing the insurance claim after adjusting the at least one line.

9. The media of claim 8, the operations further comprising:
transmitting the second electronic document to a claims management system for review by an analyst.

10. The media of claim 8, the operations further comprising:
determining, according to a modifier in the at least one line, whether the at least one line should be modified.

11. The media of claim 8, wherein modifying the at least one line comprises:
selecting one of the procedure codes from the at least one line of the electronic document representing the insurance claim; and
modifying the at least one line according to the selected procedure code.

12. The media of claim 8, wherein modifying the at least one line comprises:
modifying at least one of the explanation codes in the at least one line.

13. The media of claim 8, wherein modifying the at least one line comprises:
deleting at least one of the explanation codes in the at least one line.

14. The media of claim 8, the operations further comprising:
determining, according to the at least one procedure code in the at least one line, whether the at least one line should be modified.

15. A computer-implemented method comprising:
storing, in a database of explanation code ranks, associations between a plurality of explanation codes and a plurality of hierarchical ranks;
receiving, from a claims generator, a first electronic document representing an insurance claim, wherein the electronic document representing the insurance claim comprises at least one line, and wherein at least one line comprises at least one procedure code and at least two explanation codes;
determining hierarchical ranks from a plurality of the hierarchical ranks for the at least two explanation codes in the at least one line by at least one of:
applying the at least two explanation codes to the database of explanation code ranks, and
executing one or more logic rules selected according to the at least two explanation codes;
determining, according to the determined hierarchical ranks of the at least two explanation codes, whether the at least one line should be modified;
modifying the at least one line when it is determined that the at least one line should be modified;
ordering the explanation codes in the modified at least one line according to the hierarchical ranks;
providing a user interface comprising (i) display elements representing the modified at least one line with the ordered explanation codes and (ii) one or more user-operable controls operable by a user to adjust the at least one line;
adjusting the at least one line responsive to user operation of the one or more user-operable controls; and
outputting a second electronic document representing the insurance claim after adjusting the at least one line.

16. The method of claim 15, further comprising:
transmitting the second electronic document to a claims management system for review by an analyst.

17. The method of claim 15, further comprising:
determining, according to a modifier in the at least one line, whether the at least one line should be modified.

18. The method of claim 15, wherein modifying the at least one line comprises:
selecting one of the procedure codes from the at least one line of the electronic document representing the insurance claim; and
modifying the at least one line according to the selected procedure code.

19. The method of claim 15, wherein modifying the at least one line comprises:
modifying at least one of the explanation codes in the at least one line.

20. The method of claim 15, wherein modifying the at least one line comprises:
deleting at least one of the explanation codes in the at least one line.
